(19) United States
(12) Patent Application Publication
(10) Pub. No.: US 2014/0333497 A1
(43) Pub. Date: Nov. 13, 2014

(54) FOCAL LENS FOR ENHANCING WIDEBAND ANTENNA

(71) Applicant: Henry Cooper, Temecula, CA (US)

(72) Inventor: Henry Cooper, Temecula, CA (US)

(21) Appl. No.: 14/272,408

(22) Filed: May 7, 2014

Related U.S. Application Data
(60) Provisional application No. 61/820,584, filed on May 7, 2013.

(51) Int. Cl. H01Q 19/06

(52) U.S. Cl. CPC H01Q 19/062
USPC 343/753

(57) ABSTRACT

An RF focusing component is provided for an antenna having a formed cavity between two adjacent lobes of planar conductive material positioned on a first side of a substrate with said cavity decreasing in diameter from a widest point of said cavity to a narrowest point along angled side edges, such as a planar notch or horn wideband antenna. The focal component positioned on an opposite side of a dielectric substrate from the horn of the antenna has a body with side edges adjacent angled sided edges of the notch or horn antenna to prevent distention of RF signals communicating through narrowing regions of the horn.

### FIELD OF THE INVENTION

This application is a U.S. Nonprovisional application of U.S. Provisional application No. 61/820,584 filed on May 7, 2013. The present invention relates to antennas for transmission and reception of radio frequency communications. More particularly, the invention relates to a device and method for the improvement of the RF signal received by and generated from a planar wideband notch antenna, also referred to as a planar horn antenna, or tapered slot antenna, through the employment of a complimentary shaped layer of conducting material which acts as a focal lens component for improving the RF signal reception and transmission.

### BACKGROUND OF THE INVENTION

### Prior Art

Many antenna designs, types, and constructions are known in the art to provide wireless electronic communication for radios, televisions, and cellular telephones and have come to define the wireless information age that we live in. The communication of radio frequency (RF) signals to and from various antennas, is accomplished through the reception and transmission of these signals within a radiation and reception element in these antennas. The quality, clarity, and adaptable frequency ranges are directly related to the type, size, shape, and other properties of the radiation and reception element as well as the overall antenna construction.

It has conventionally been a goal in prior art to provide improvements, modifications, and enhancements of known antenna designs, in order to improve reception and transmission qualities of the antennas in order to accurately send and receive quality signals. The present invention employing a conductor as a novel lens component provides an improvement in wideband notch or horn style antennas.

Conventionally employed notch or horn antennas employ a tapered open cross section of a conductor for broadcast and reception of RF energy over a range of frequencies. Such construction yields a broadband-antenna, which is formed on a planar dielectric substrate having metallized or other conductive material surfaces engaged on a first side and a pick up engaged through the dielectric on the opposing side.

In this construction an RF radiator element and receiver element is formed on the first side surface. The radiator and receiver element is formed by a cavity or relief in the planar conductive material formed in between opposing nodes of the conductive material. Such can be in the form of a horn having a straight, curved, or serpentine edges. The cavity extends from a gap at a widest point defining a mouth of the cavity, to a narrowest point defining a throat of the cavity.

A feed line or pickup is engaged to the antenna on the opposite side of the dielectric planar material adjacent to the throat region of the cavity. The feedline communicates energy at the communicated frequencies captured and transmitted by the antenna element at or near the throat region to provide a smooth field transition for energy to and from the antenna element.

Typically the widest point of the cavity, between the two points of the radiator halves or nodes, determines the low point for the frequency range of the element. The narrowest point of the cavity between the two halves determines the highest frequency to which the element is adapted for use. Thus, through modification of these parameters, conventional Vivaldi-antennas are exceptionally well suited for broadband frequency communication.

However, there is a problem with notch or horn type antennas and antennas of similar construction, which the present invention solves. In such antennas, the RF energy or signal communicating through the throat region of the formed planar cavity, tends to distend or curve away from the plane slightly as it reciprocates or enters between the edge or two side walls of the horn like cavity. This distension occurs from the widest point through the narrowing throat region, until ultimately being picked up by the feedline. It is believed this distention is a result of the narrowing throat region causing the signal to speed up and compact within the narrower throat. These effects are increased when signals at the low frequency range are received since they are picked up at the wider mouth region of the cavity, and must be communicated through the narrowing throat. This typically results in slight to substantial inaccuracies and inconsistences of the received signal.

As such, there is a continuing and unmet need for an improved or improvement in the performance of a planar notch or horn antenna device formed with a sloping or decreasing cavity. Such a device and method would provide a focal structure for correcting the distending of the RF signal and the resulting inaccuracies during the communication of signals through the narrowing throat region of the horn-like cavity of the radiator and reception element. Such a device should be capable of employment with notch or horn antennas formed for wideband frequency reception and transmission. Such a device should be formed employing conventional materials and methods which allow for its inclusion on conventional assembly lines for planar notch, horn, and similar antennas to improve their RF performance. Finally, such a device and method should be employable to retrofit existing such antennas with a focal lens to improve their performance.

The forgoing examples of related art and limitation related therewith are intended to be illustrative and not exclusive, and they do not imply any limitations on the invention described and claimed herein. Various limitations of the related art will become apparent to those skilled in the art upon a reading and understanding of the specification below and the accompanying drawings.

### SUMMARY OF THE INVENTION

The device and method herein disclosed and described provides a solution to the shortcomings in prior art in planar horn, notch, and similar wideband antennas, and achieves the above noted goal through the provision of a complimentary shaped conductor component shaped and positioned to act much like a lens structure when employed in combination with the cavity of a slot or horn antenna. The conductor component defining this lens structure is formed of an RF attractive or conducting material such as copper which is operatively positioned on a dielectric substrate material. When this conducting component is properly shaped and positioned, it works in concert with the receiving portion of the antenna on the opposite side of the substrate, and corrects distending RF signals in the antenna cavity. This correction of the distending RF signals, which result in signal inaccuracies during the communication of RF signals from and into the narrowing throat region if the antenna, increases gain and throughput to an engaged device employing the received signal.

While shown in position on an exemplar horn notch antenna in a combination therewith, the device and method herein is capable of employment in a method for enhancing existing horn and notch antennas and for employment as part of newly manufactured new horn and notch antennas to also enhance their function.

The device and method herein, provides a planar conductor component positioned upon the opposite side from narrowing section of the horn or notch antenna structure. So positioned and complimentary in shape, the conductor component serves as a focal lens for the RF energy received and transmitted from the antenna on the opposing side of the substrate. So positioned and engaged, the planar conductor component forming this RF focal lens achieves an improved reception of RF energy in proper phase and with increased gain as well as an improved RF transmission in a planar notch or horn antenna device.

The planar conducting component forming the RF focal lens device is preferably formed on a second surface of the non-conductive substrate or dielectric material opposite the planar first surface occupied by the conductive material formed to the RF radiator and reception element. A feedline for transmission of electronic signals to and from the formed antenna is positioned on the second surface of the substrate and in operative communication with the antenna formed on the first surface. The conducting component formed of conductive material in the configuration provided an RF lens enhances both the RF signal reception and broadcast by the antenna element on the first surface of the substrate.

It is briefly noted that upon a reading of this disclosure, those skilled in the art will recognize various means for carrying out these intended features of the antenna enhancing invention herein. As such it is to be understood that other device, methods, applications and systems employing components configured to carry out these features may be envisioned however are considered to be within the scope and intent of the present invention, and are therefor anticipated.

In accordance with at least one preferred mode, the focal lens component is formed in an operative dimension from a conductive material such as copper. The copper forming the conductive component is operatively shaped and formed for an engagement to the surface of the substrate, opposite and in a symbiotic relationship with the cavity formed in the engaged radiator element.

The conducting component forming the lens element is shaped complimentary to the dimensions of the area of the narrowing throat region of the radiator element on the opposing side of the substrate to substantially cover it and has side edges which may be complimentary in position and shape to the angled narrowing side edges forming the cavity in the antenna element. In this location, the focal lens component being formed of conductive material has been found in experimentation to provide a symbiotic relationship with the formed antenna element by improving the linear quality and gain of the RF signals being communicated into the narrowing region of the antenna component from the wider mouth thereof to the engaged feeling in a narrowing throat region. Experimentation has shown that by operatively positioning the focal lens component as such, the symbiotic relationship substantially prevents the RF distension which frequently occurs in notch or horn antennas formed in a planar surface, through a straightening and focusing of the RF signal, as it is accelerated up and compacted through the narrowing throat region. Thus, a significant improvement in RF signal reception, quality, and accuracy is achieved.

Further, it is particularly preferred, that the focal lens component placed to oppose the narrowing cavity or horn, is formed in a shape cooperative with the shape of the narrowing cavity of the horn or notch. In the current mode, the planar conductor forming the lens has the general appearance of a triangle, with angled or curved sidewalls which substantially match or mirror the angle, curve, or serpentine shape of the side edges of the cavity of the horn formed between the two nodes of conductive material, forming the RF radiator element thereof.

Experimentation has also shown that this shape and form of the conductive material forming the conducting element defining the focal lens, when operatively positioned in an engagement on the second surface of the substrate opposite the radiator element on the first surface, and with side edges of the conducting component substantially aligned with the inner edges of the mouth formed in the horn defining the narrowing throat region of the radiator element, provides the most improvement in RF signal reception. Experimentation has shown this can be caused by preventing or significantly reducing distention of the RF signals during their passage along the narrowing throat region or cavity of the notch or horn antenna.

The device may be employed in combination with a single antenna in a single element or may be employed in individual symbiotic relationships within arrays of interconnected individual elements electrically connected to an array. Further, the conducting component forming the RF focal lens can be retrofit to existing broadband notch and horn configured antennas to improve the receipt and transmission RF signals.

Depending on the high and low cutoff frequencies defined by the formed cavity of the notch or horn antenna elements, the individual arrays may be employed for HDTV, WiFi, Radio, cellular, MIMO and other multi-stream 3G and 4 G communication's schemes with exceptional performance and, through changes in the formed widest and narrowest points of the formed horn, can be adapted to virtually any RF frequency range.

The unique configuration of the individual antenna radiator elements in combination with a conducting component forming an RF focal lens component operatively engaged on the opposing side of the substrate, for providing exceptionally clear and accurate signal reception, provides enhanced gain resulting in excellent transmission and reception performance in a wide band of frequencies only limited by the maximum width of the mouth of the cavity of the notch or horn, and the minimum distance at the opposite end of the cavity.

The notch or horn antenna, forming radiating and reception element of the antenna device, is preferably formed of planar conductive material and positioned on a single side of a dielectric substrate of such materials as MYLAR, fiberglass, REXLITE, polystyrene, polyimide, TEFLON, fiberglass or any other such material suitable for the purpose intended. The substrate may be flexible. However, in one particularly preferred mode of the device wherein a plurality of antenna elements are engaged to each other to increase gain or broadcast and receipt footprint, the substrate is substantially rigid in nature.

The radiator and reception element formed on the substrate can be any suitable conductive material, as for example, aluminum, copper, silver, gold, platinum or any other electrically conductive material suitable for the purpose intended. The conductive material is adhered to the substrate by any conventional known technology.

However, in at least one preferred mode, the radiator element providing reception and if desired, transmission of broadcast RF signals, in combination with the disclosed invention is based upon a planar antenna element formed by printed-circuit technology defining a wideband notched antenna having a narrowing cavity defined by the side edges running along two opposing nodes. The radiator element is of two-dimensional construction formed in a manner similar to a conventional Vivaldi, horn or notch antenna type.

In a particularly preferred mode, the notch or horn antenna forming the radiator and reception element is formed in the conductive planar material on the first side of the dielectric substrate which is currently between 2 to 250 mils thick. Angled edges running along the two nodes define the dimensions of a gap or declining throat in the conductive material, in between opposing nodes.

In the depicted mode herein, this throat takes the shape of a horn having a first angle to a point on the side edges which changes to a secondary angle as the throat area narrows. From the narrowest point of the throat, a passage having a straight, curved or serpentine extension turns parallel a imaginary line extending between the widest point of the formed cavity which also defines a mouth of the cavity. The formed cavity between the opposing nodes, has the general appearance of a cross-section featuring two nodes or half-sections in a substantially mirrored configuration extending from a center, to widest points on an edge, positioned a distance from each other at their respective edges of opposing nodes. From a top plan view the disclosed throat area resembles a champagne glass or the open end of a trumpet.

The cavity beginning with an uncoated or unplated surface area of the substrate between the termination of the side edges of both nodes at the respective tips the two nodes defines the mouth of the cavity. The cavity is substantially centered between the two distal points on each node.

The formed cavity between opposing nodes extends substantially perpendicular to a horizontal line running between the two points defining the mouth and widest point, and then communicates with a tail portion which curves into the body portion of one of the nodes and extends away from the other node, in a direction parallel with the line defining the mouth.

Along the cavity pathway, from the points of the element halves or antenna nodes at the widest point, the cavity narrows continually in its cross sectional area. As shown the angle of declination toward the center of the cavity, increases at points equidistant along the side edges of the nodes.

The cavity is at a widest point between the two points on opposing nodes, and narrows to a narrowest point. The cavity from this narrow point then extends to a tail curvilinear portion which curves to extend to a distal end within the one opposing node, where it makes a right angled extension from the centerline of the declining cavity. The area of uncovered substrate occupied by this tail section has a direct effect upon the antenna impedance and as such is adjusted in area for impedance matching purposes.

The widest point of the cavity between the two points of the radiator halves or nodes, determines the low point for the frequency range of the element. The narrowest point of the cavity between the two halves determines the highest frequency to which the element is adapted for use. A current favored configuration has a widest point of the radiator element between 1 and 2 inches, and the narrowest point yielding the highest frequency reception and transmission between 0.008 and 0.016 inches. The preferred conductive material for both radiator element and focal lens component is currently copper being 0.01 inches thick on a dielectric substrate of about 0.03 inches thick to optimally space the focal lens component formed on the opposite surface from the radiator element.

Of course those skilled in the art will realize that by adjusting the widest and narrowest distances of the formed cavity, the element may be adapted to any desired frequency ranges and any antenna element which employs two substantially identical leaf or node portions to form a cavity therebetween with maximum and minimum widths is anticipated within the scope of the claimed device herein.

On the second or opposite surface of the substrate from the formed radiator element, a feedline extends from the area of the cavity substantially intermediate the first and second nodes on each side of the cavity forming the radiator element, and communicates energy at the communicated frequencies captured and transmitted by the antenna element at or near the throat region to provide a smooth field transition for energy to and from the element.

The location of the feedline connection, the size and shape of the two halves of the radiator element, and the cross sectional area of the cavity may be of the antenna designers choice for best results for a given use and frequency. Currently, a linear path parallel to the imaginary line defining the mouth of the cavity, and then curve of the curvilinear tail portion of the cavity toward the portion defining the narrowest point of the cavity is favored due to exceptional gain and other characteristics.

Of course those skilled in the art will realize that shape of the half-portions and size and shape of the cavity may be adjusted to increase gain in certain frequencies or for other reasons known to the skilled, and any and all such changes or alterations of the depicted radiator element as would occur to those skilled in the art upon reading this disclosure are anticipated within the scope of this invention.

With respect to the above description, before explaining at least one preferred embodiment of the herein disclosed invention in detail, it is to be understood that the invention is not limited in its application to the details of construction and to the arrangement of the components in the following description or illustrated in the drawings. The invention herein described is capable of other embodiments and of being practiced and carried out in various ways which will be obvious to those skilled in the art. Also, it is to be understood that the phraseology and terminology employed herein are for the purpose of description and should not be regarded as limiting.

As such, those skilled in the art will appreciate that the conception upon which this disclosure is based may readily be utilized as a basis for designing of other structures, methods and systems for carrying out the several purposes of the present disclosed device. It is important, therefore, that the claims be regarded as including such equivalent construction and methodology insofar as they do not depart from the spirit and scope of the present invention.

As used in the claims to describe the various inventive aspects and embodiments, “comprising” means including, but not limited to, whatever follows the word “comprising”. Thus, use of the term “comprising” indicates that the listed elements are required or mandatory, but that other elements are optional and may or may not be present. By “consisting of” is meant including, and limited to, whatever follows the phrase “consisting of”. Thus, the phrase “consisting of” indicates that the listed elements are required or mandatory, and that no other elements may be present. By “consisting essentially of” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they affect the activity or action of the listed elements.

The objects features, and advantages of the present invention, as well as the advantages thereof over existing prior art, which will become apparent from the description to follow, are accomplished by the improvements described in this specification and hereinafter described in the following detailed description which fully discloses the invention, but should not be considered as placing limitations thereon.

### BRIEF DESCRIPTION OF DRAWING FIGURES

The accompanying drawings, which are incorporated herein and form a part of the specification, illustrate some, but not the only or exclusive, examples of embodiments and/or features. It is intended that the embodiments and figures disclosed herein are to be considered illustrative rather than limiting. In the drawings:

FIG. 1 shows a front view of the antenna device showing the radiator element.

FIG. 2 shows a rear view of the device showing the feedline and focus lens component.

FIG. 3 shows a front view of the device and showing the preferred location and positioning of the feedline and focus lens component depicted in dashed lines.

FIG. 4a shows a view of prior art Vivaldi-antenna type horn antennas depicting the distension of the RF signal passing through the narrowing throat region of the radiator and reception element.

FIG. 4b shows the antenna of the present invention employing the focal lens component and the resultant straightening of the RF signal communicating in into the narrowing throat region, thereby improving signal reception quality by maintaining phase and other aspects of the transmitted or broadcast signal.

Other aspects of the present invention shall be more readily understood when considered in conjunction with the accompanying drawings, and the following detailed description, neither of which should be considered limiting.

### DETAILED DESCRIPTION OF THE PREFERRED EMBODIMENTS OF THE INVENTION

In this description, the directional prepositions of up, upwardly, down, downwardly, front, back, top, upper, bottom, lower, left, right and other such terms refer to the device as it is oriented and appears in the drawings and are used for convenience only; they are not intended to be limiting or to imply that the device has to be used or positioned in any particular orientation.

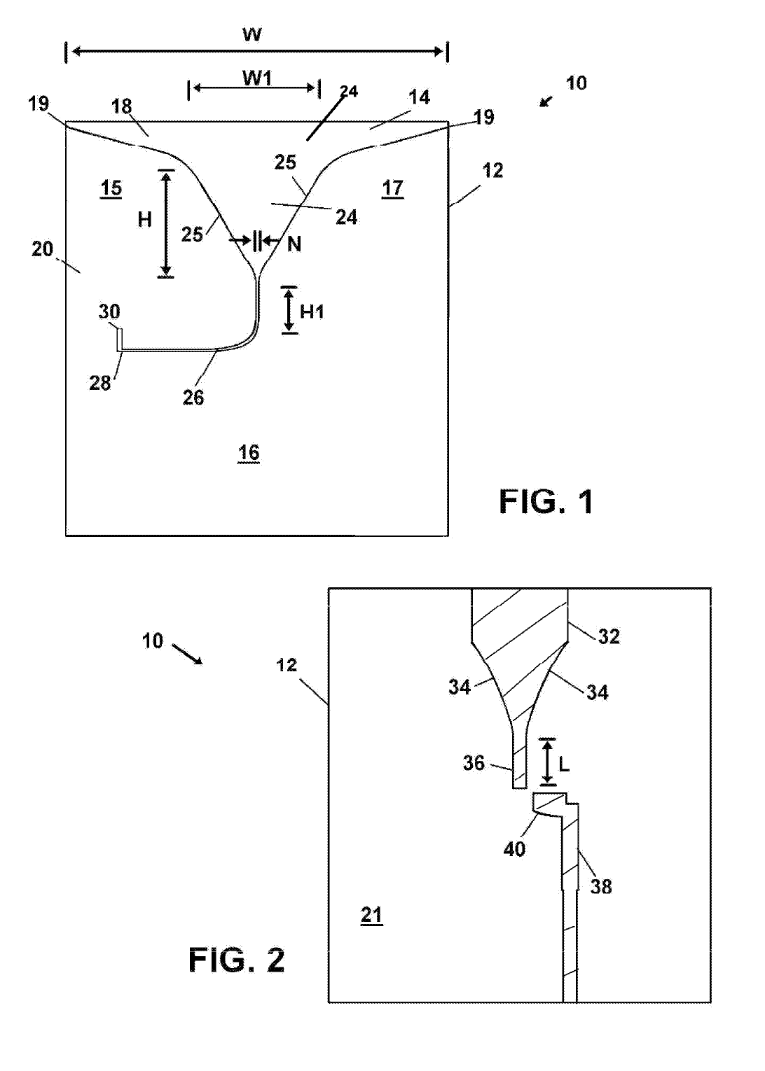

Now referring to drawings in FIGS. 1-4b, wherein similar components are identified by like reference numerals, there is seen in FIG. 1 depicting a formed wideband antenna element 12 employed in combination with method and the device 10 herein. The antenna element 12 is shown having two half portions or nodes which are formed by a first node 15 and second node 17 being substantially identical or mirror images of each other.

The antenna element 12 of the invention is formed of planar conductive material positioned on a dielectric substrate 14 which as noted is non conductive and may be constructed of either a rigid or flexible material such as, MYLAR, fiberglass, REXLITE, polystyrene, polyamide, TEFLON fiberglass, or any other such material which would be suitable for the purpose intended.

The first surface 20 is coated with a conductive material 16 by microstripline or the like or other metal and substrate construction well known in this art. Any means for affixing the conductive material 16, to the substrate 14, to form the antenna element 12 herein, is acceptable to practice this invention. The conductive material 16 for example, may include but is not limited to aluminum, copper, silver, gold, platinum or any other electrical conductive material which is suitable for the purpose intended.

As shown in FIG. 1, the surface conductive material 16 on first surface 20 is etched away or otherwise removed by suitable means, or left uncoated in the coating process, to form the first and second nodes 15 and 17 of the antenna element, which each have angled side edge 25 defining the notch area which has a mouth 18 leading to a curvilineal portion of the defined cavity 24 extending from the narrowest point of the two sidewalls 25.

The cavity 24 defined by the side edges 25 and extending from a mouth 18 has a widest point “W” and extends between the angled or curved side edges 25 of the two nodes 15 and 17 to a narrower point “W1” of the mouth 18, and further leading into the narrowing throat section ‘H” of the cavity 24 to the narrowest point “N” of the cavity 24 which is substantially equidistant between the two distal tips 19.

The widest distance “W” of the mouth 18 portion of the cavity 24 running between the distal end points 19 of the radiator halves 15 and 17, determines the low point for the frequency range of the device 10. The narrowest distance “N” of the cavity 26 between the two halves 15 and 17 determines the highest frequency to which the device 10 is adapted for use.

Further, the narrower distance “W1” at a transition point along both side edges 25, begins an increase in the angle of declination of the side edges 25 from that extending from the generally wider mouth 18. This increase in the angle of the sidewalls 25 continues toward the narrowest point “N.”

From cavity 24 proximate to the narrowest distance “N”, a tail 26 portion of the cavity 24 extends a distance “H1” before curving into the body portion of the first node 15 and extends away from the other the second node 17. The cavity 24 then extends to a distal end 28 within the first node 15 where it makes a substantially right angled extension 30 as shown. This substantially right angled extension 30 having no conductive material, when adjusted in area or shape, provides a means for impedance matching by adjusting the capacitance of the formed antenna element 12 to the feed line inductance.

On the opposite surface 21 of the substrate 14 shown in FIG. 2, a feedline 38 having a patch portion 40 extends from the area of the cavity 24 intermediate the two nodes 15 and 17 forming the two halves of the radiator element 12 and passes through the substrate 14 to electrically connect to the first node 15 and second node 17 adjacent to the edge 25 of the curved portion of the tail 26 cavity 24 just past the vertical extension “H1”.

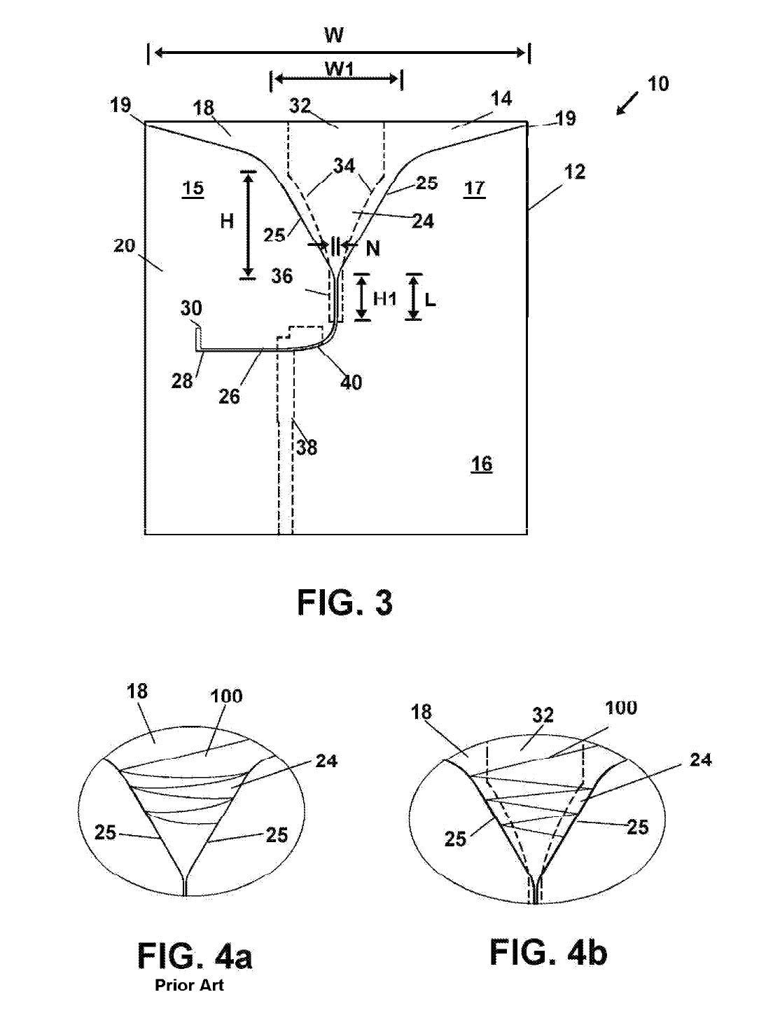

Further as can be clearly seen in the rear view depicted in FIG. 2, and the front view showing the first surface in FIG. 3, showing the location of the conductive component 32 in dashed lines, it is particularly preferred that a focal lens defined by the conductive component 32 is formed from a conductive material configured in shape and size to extend from the area of the cavity 24 intermediate the two nodes 15 and 17 at or near edge of the substrate defining widest distance W of the mouth 18.

The focal lens defined by the conductive component 32 is preferably dimensioned having the general appearance of a triangle, with angled or curved sidewalls 34 which substantially match or emulate the angle, curve, or serpentine shape of the side edges 25 of the nodes 15, 17, extending below the intermediate point an in the narrowing throat section H of the cavity 24 forming the radiator element 12 thereof. The conductive component 32 has two parallel edge portions communicating between the start of the two sidewalls 34 and the edge of the substrate in the center of the mouth 18.

Experimentation has shown that this shape and form of the focal lens component 32, when operatively positioned in an engagement on the surface 21 of the substrate 14 opposite the radiator element 12, and substantially aligned with the throat region H of the radiator element 12, acts in a symbiotic relationship with the radiator element 12 providing the most improvement in signal reception by preventing distention of the signals communicating through the narrowing throat region H as depicted in FIGS. 4a-4b.

For example, FIG. 4a shows a view of a conventional Vivaldi- or notch or planar horn type antenna herein described as existing art, depicting a distension of the RF signal 100 passing through the narrowing sidewalls 25 of the throat region. The signal 110 tends to curve rather than remain linear as it progresses down the throat region.

FIG. 4b depicts the symbiotic effect of the RF focal lens of the conductive component 32 once engaged to the opposing surface in combination with such Vivaldi, notch, or horn type antennas. The focal lens component 32 operationally engaged, and having side edges which run adjacent to the side edges 25 in the throat region on the opposite side, provide a significant improvement in signal reception and transmission is achieved through a focusing and straightening of the RF signal 100 passing into and from the narrowing throat region.

In addition, the focal lens of the conductive component 32 preferably includes a narrow, substantially rectangular tail portion 36, which extends a distance ‘L’. The positioning and location of the focal lens component 32, as seen in FIG. 3, preferably aligns the tail portion 36 extending the distance ‘L’ substantially matching the distance H1 of the vertical portion of the tail 26 of the cavity 24 extending below the narrowest point “N”. This feature has also been shown to provide additional improvement in signal reception by preventing distention of the RF signals communicating through the narrowing throat region H, and is preferred.

The location of the feedline 38 and patch 40, focal lens component 32, the size and shape of the two halves 15 and 17 of the antenna element 12, and the cross-sectional area of the distances “W”, “W1”, “N”, “H”, and “H1”, and the change in slope angle of the side edges 25, 34, are adapted in size and distance to receive captured energy at a wide range of frequencies and in this configuration allows for modifications to performs well and across the entire RF bandwidth and is especially preferred.

The shape of the conductive component 32 is most important in the angled edges 34 in that while they need not match exactly the angle of the side edges 24 they should run adjacent thereto to the rectangular tail section 36 which should cover the area of the area of the cavity 24 extending past the narrowest point “N” between the angled side edges 25.

Of course, those skilled in the art will realize that by adjusting the widest and narrowest distances of the formed cavity 24, the antenna element 12 (notch, horn, etc.) may be adapted to other frequency ranges and any antenna element which employs two substantially adjacent node portions to form a cavity of dielectric material therebetween having a declining width as shown and described is anticipated within the scope of the claimed device 10 herein and will benefit from the addition of a focal lens defined by the conducting component 32 on the opposing side of a centrally located dielectric material.

While the current preferred mode of the shape of the focal lens component 32 is substantially triangular and of a shape complimentary to the formed cavity 24, as noted it need not match exactly the angle of the side edges 25 to yield significant improvement. Further each antenna has individual components which may affect the RF signal so some tuning of the shape of the focal lens component 32 is anticipated within the scope of this patent. Further it is anticipated that existing notch and horn style antennas can be retrofitted to include a focal lens component 32 and such is anticipated within the scope of this application.

In addition, those skilled in the art will recognize various modifications to the focal lens component 32 needed to adapt to various geometries of the radiator element 12 for the purpose of preventing the distension, through a straightening and focusing of the signal, as it is being speed up and compacted through the narrowing throat region H, and are also anticipated within the scope of this invention.

This invention has other applications, potentially, and one skilled in the art could discover these. The explication of the features of this invention does not limit the claims of this application; other applications developed by those skilled in the art will be included in this invention.

It is additionally noted and anticipated that although the device is shown in its most simple form, various components and aspects of the device may be differently shaped or slightly modified when forming the invention herein. As such those skilled in the art will appreciate the descriptions and depictions set forth in this disclosure or merely meant to portray examples of preferred modes within the overall scope and intent of the invention, and are not to be considered limiting in any manner.

While all of the fundamental characteristics and features of the invention have been shown and described herein, with reference to particular embodiments thereof, a latitude of modification, various changes and substitutions are intended in the foregoing disclosure and it will be apparent that in some instances, some features of the invention may be employed without a corresponding use of other features without departing from the scope of the invention as set forth. It should also be understood that various substitutions, modifications, and variations may be made by those skilled in the art without departing from the spirit or scope of the invention. Consequently, all such modifications and variations and substitutions are included within the scope of the invention as defined by the following claims.

What is claimed:

1. In an antenna having a formed cavity between two adjacent lobes of planar conductive material positioned on a first side of a substrate with said cavity decreasing in diameter from a widest point of said cavity to a narrowest point along angled side edges, such as a planar notch or horn wideband antenna, the improvement comprising:
a conductive component positioned on a second side of said substrate from said formed cavity;
said conductive component positioned on said second side of said substrate in an area opposite a central portion of said cavity;
said conductive component configured in shape with angled sides following a path along or adjacent an angle of said side edges toward each other from a narrowest gap between said side edges, to a wider gap between said side edges; and
said conductive component in a symbiotic electrical relationship with said with said antenna as a means for preventing distention of RF signals communicating through said throat along narrowing regions thereof.

2. A wideband antenna element with enhanced operating capability in predetermined frequency ranges, comprising:
a substrate;
a first substrate surface, a portion of which is covered with a conductive material, and a portion of which is uncovered;
said conductive material forming a pair of lobes having substantially similar shapes, said lobes each extending in opposite directions to distal tips;
a first cavity formed on said uncovered portion defined by side edges of each of said lobes;
said first cavity having a widest distance between said two side edges of said lobes at a mouth portion, said mouth portion beginning at a first edge of said substrate along a line extending between said distal tips;
said first cavity reducing in cross section from a widest point to a central point, according to a first slope of opposing said side edges of each of said lobes;
said first cavity thereafter extending away from said narrowest point in a linear portion for a distance to a curved portion extending into a first one of said lobes; and
a feedline electrically communicating along said curved potion for communicating RF signal to and from said antenna;
a conductive component formed of conductive material positioned on a second side of said substrate from said cavity;
said conductive component positioned on said second side of said substrate from an area occupied by a central portion of said cavity;
said conductive component configured in shape with a pair of angled sides with each following an intersecting path along or adjacent a pathway followed by respective said side edges of said lobes along said first slope, to a narrowest gap therebetween; and
said conductive component in a symbiotic electrical relationship with said with said first cavity and said side edges as a means for preventing distention of RF signals communicating through said throat along narrowing regions thereof.

3. The wideband antenna element of claim 2, additionally comprising:
a rectangular portion of said conductive component defined by an area of said conductive material extending between two parallel side edges from said first edge of said substrate to a beginning of said path followed by said angled sides of said conductive component.

4. The wideband antenna element of claim 3, additionally comprising:
a rectangular tail portion extending from a closest point of said angled sides of said conductive component, said rectangular tail portion positioned on an area of said second side of said substrate opposite said linear portion of said first cavity.
